(19) United States
(12) Patent Application Publication
(10) Pub. No.: US 2005/0236756 A1
(43) Pub. Date: Oct. 27, 2005

(54) Holding device for generating a retaining pressure on an airplane component

(76) Inventor: Juergen Otten, Tiste (DE)

Correspondence Address: FASSE PATENT ATTORNEYS, P.A., P.O. BOX 726, HAMPDEN, ME, 04444-0726, US

(21) Appl. No.: 11/090,922

(22) Filed: Mar. 24, 2005

Related U.S. Application Data
(60) Provisional application No. 60/606,647, filed on Sep. 2, 2004.

(30) Foreign Application Priority Data
Mar. 27, 2004 (DE) 10 2004 015 172.5

(51) Int. Cl. B25B 5/16

(52) U.S. Cl. 269/266

(57) ABSTRACT

A holding device produces a retaining pressure on a contoured airplane component (40) for holding the component in place when work is performed on the component. For this purpose the holding device (10) comprises a support (11) and at least one holding element (16) connected to the support (11) and projecting from the support (11) for contacting the contoured airplane component (40) in a holding zone. A spacing between a contact area of the holding element (16) and the support (11) is adjustable in accordance with the contour of the airplane component (40) in the holding zone. The adjustment of the position of the holding element relative to the support (11) moves the holding element (16) more or less against the surface contour so that the holding force is applied exactly where needed on the holding zone. A plurality of holding elements can be advanced toward the surface contour to variable extents so that all contact areas together conform to the surface contour.

### CROSS-REFERENCE TO RELATED APPLICATION

This U.S. Non-Provisional Application claims the benefit under 35 U.S.C. §119(e) of U.S. Provisional Application 60/606,647, filed on Sep. 2, 2004, the entire disclosure of which is incorporated herein by reference.

### PRIORITY CLAIM

This application is based on and claims the priority under 35 U.S.C. §119 of German Patent Application 10 2004 015 172.5, filed on Mar. 27, 2004, the entire disclosure of which is incorporated herein by reference.

### FIELD OF THE INVENTION

A holding device for generating a retaining pressure on an airplane component has a support and at least one holding element held by the support and projecting from the support for contacting the airplane component in a holding zone. The spacing of the contact area of the holding element from the support is set in accordance with the contour of the airplane component in the holding zone.

### BACKGROUND INFORMATION

When working an airplane component, for example when drilling holes in an airplane component with a drilling unit, a holding device is used in order to apply a holding pressure to the airplane component, such as two skin sections that may not shift relative to each other while drilling continues. The holding pressure counteracts the force applied by the drilling unit to the airplane component. Such a holding pressure may, for example, also be required for preventing the entry of drilling chips into intermediate spaces between airplane components to be interconnected. Conventionally, a support plate with a plurality of holding pins is, for instance, provided for a determined zone on the surface of an airplane component. Depending on the contour of the airplane component in this zone the holding pins project out of the support plate by an individually set spacing in which the pins remain in order to achieve a contour true adaptation and thus a uniform holding pressure of the holding pins in the determined zone on the airplane component. Thus, for each determined zone of the surface of an airplane component a holding device is required that is individually adapted to the respective contour. Once the contour defined by the pin ends is set, the holding device can be used only on an airplane component zone having the same surface contour. The set pins can not be used on any other surface contour. Therefore, the stocking and handling of a multitude of individual holding devices is unavoidable, complicated, and expensive. Keeping many holding devices in stock is necessary because if an airplane component contour deviates from the contour defined by the set pin ends contacting the surface of the airplane component may not be optimal. Some pins may contact the component surface while some may not. Thus, there is the danger that drilling chips enter into the intermediate spaces between two airplane components to be interconnected.

### SUMMARY OF THE INVENTION

It is an object of the invention to provide a holding device that can be handled simply and quickly, that requires a small effort and expense, and that is particularly exactly adaptable to any different surface contour. It is another object to make the pin position individually variable or adjustable so that the tips of all pins together can form or define different contours, preferably settable or lockable different contours.

It is still another object to permit all holding pins to automatically adjust their position relative to any surface contour in unison simply by setting the holding device onto the respective surface contour and then lock the pins in place until another contour needs to be held down.

These objects have been achieved according to the invention in that the holding element is shiftable or adjustable relative to the support so that the spacing of the contact area of the holding element from the support is variable. In the embodiment with a plurality of holding pins the tips of the pins form the contact area. This adjustment makes it possible that the holding device, when applied to the airplane component surface, adapts itself to the respective component contour by shifting of the at least one holding element. Thus, a single holding device is universally adaptable to and useable for a plurality of differing contours on the surface of an airplane component, whereby the number of holding devices to be stocked is reduced and thus the effort and expense is correspondingly reduced. A manual adjustment of the at least one holding element is not necessary. The holding device can be used sequentially for different component zones by resetting. This feature assures a swift work flow.

The holding device preferably comprises a locking mechanism for temporarily locking the at least one holding element in a fixed position relative to the support. After the holding device has been applied to the airplane component and the holding element has been adapted or adjusted to the component contour by freely shifting the holding element relative to the support plate toward or away from the surface contour, the locking mechanism is operated so that the holding element can exert a holding pressure on the airplane component. The locking mechanism may preferably be controllable, for example electrically, pneumatically or hydraulically. However, the invention also encompasses a manual activation of the locking mechanism. Further, one locking mechanism is preferably allocated to a plurality of holding elements in order to quickly and simultaneously lock all the holding elements in position.

Preferably, the holding element is hydraulically shiftable or adjustable. Thereby, particularly the locking of the holding element is especially simply realized by closing the hydraulic system, for example, by simply closing a valve. The invention, however, also encompasses electrically shiftable holding elements, for example by an electric motor.

In another embodiment the adjustment of each holding element is controllable with regard to its shifting relative to the support or support plate. Thus, each holding element can then be adjusted contour-true for the use in a determined holding zone of an airplane component. This feature makes it possible, for example, to store in a memory the adjustment of the holding elements for different component contours and to automatically make a respective adjustment depending on the desired use of the holding device, more specifically depending on the surface contour to be held. The adjustment values to be stored can be ascertained by means of a calibration of the holding device.

The invention further aims to avoid or overcome the disadvantages of the prior art, and to achieve additional advantages, as apparent from the present specification. The attainment of these objects is, however, not a required limitation of the claimed invention.

### BRIEF FIGURE DESCRIPTION

In order that the invention may be clearly understood, it will now be described in connection with example embodiments thereof, with reference to the accompanying drawings, wherein:

FIG. 1 shows a cross-sectional view of a holding device in a rest position; and

FIG. 2 shows a cross-sectional view of a holding device set on an airplane component.

### DETAILED DESCRIPTION OF A PREFERRED EXAMPLE EMBODIMENT AND OF THE BEST MODE OF THE INVENTION

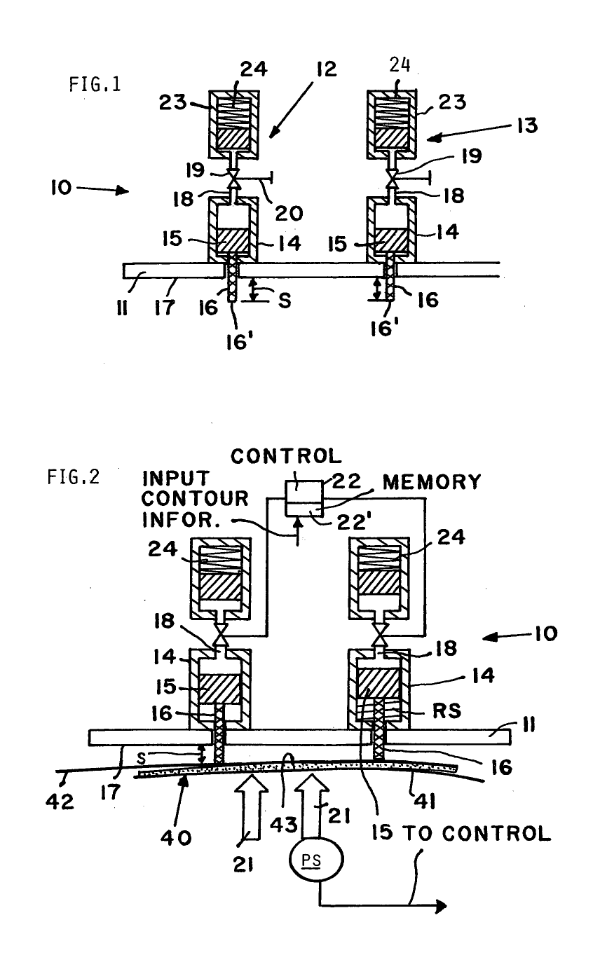

A holding device 10 comprises a support plate 11 and at least one, preferably a plurality of holding sections 12, 13 mounted on the support plate. In this example the holding sections 12, 13 are equally constructed. However, such identical construction is not necessarily the case. For example, each holding section may be constructed with due regard to its position within a group of holding devices. Each holding section 12, 13 comprises for example a hydraulic cylinder 14 with a piston 15 shiftable in the cylinder to form a drive for a holding element 16 such as a pin. The piston 15 is connected with the pin 16 which is guided through a hole in the support plate 11 and which projects from a surface 17 of the support plate 11 facing toward an airplane component 40 to be held. The hydraulic cylinder 14 is filled with hydraulic liquid on the side of the piston 15 opposite the pin 16. The cylinder 14 has a port 18 connected to a hydraulic liquid reservoir 23. The port 18 is closeable by a valve 19 that provides either a manual or an automatic control for locking the respective pin 16 or pins in a fixed position. A reset spring RS may be provided in the cylinder to return the piston with the pin into a starting position when the pressure on the opposite end of the piston is released. However, such a reset spring is not necessary if all pins 16 project completely out of the support plate 11 when the pins are in a rest or starting position as shown in FIG. 1 where all pins 16 with their surface contact areas 16′ extend maximally out of the support plate 11 with a spacing S between the contact area 16′ and the downwardly facing surface of the support plate 11.

FIG. 1 shows the projected rest or starting position of the holding device 10 in which the pins 16 of the holding sections 12, 13 project maximally out of the support plate 11. When the holding device 10 is now set onto a contoured surface 43 of an airplane component 40 the pins 16 will more or less move back into the cylinder 14 as shown in FIG. 2 where the spacings S differ from each other so that the contact areas 16′ of the pins 16 conform to the surface contour 43. The airplane component 40 comprises for example a section of an outer airplane skin 41 and a section of an inner airplane skin 42. A certain holding zone of the component skin sections 41, 42 is to be worked, for example by drilling. These skin sections 41, 42 may be part of an airplane wing. In the area to be worked the contoured surface 43 of the airplane component 40 has a determined curved shape, i.e. the surface is not plane. When the holding device 10 is set onto the contoured surface 43 of the airplane component 40 in the zone to be worked, the pins 16 of the holding sections 12, 13 are shifted by the contact force relative to the hydraulic cylinders 14 or relative to the support plate 11. The size of the shifting of the pins 16 depends on the contour of the airplane component 40 at the position of the respective pin 16 so that an individual adaptation of the pins 16 of the holding device 10 to the contour 43 of the airplane component 40 takes place. The shifting of the piston 15 displaces a corresponding quantity of hydraulic liquid out of the hydraulic cylinder 14 through the port 18.

The valve 19 is closed when all pins 16 are in the holding position, i.e. when all pins 16 of the holding sections 12, 13 contact the airplane component 40. The closing of the valve 19 can be performed, for example, by an electric, a hydraulic or a pneumatic, an electromagnetic, or a piezo-electric control signal through a control conductor 20. The holding device 10 comprises for this purpose preferably an electronic control mechanism 22. A manual operation of the valve 19 is also possible. Furthermore, rather than providing the hydraulic liquid reservoir 23 individually for each holding section 12, 13 as shown in FIG. 1, a single reservoir may be provided in common for several or all holding sections 12, 13. In that case the use of a single valve for closing the reservoir may be sufficient, so that a separate valve 19 for each holding section 12, 13 is not necessary.

Due to the incompressibility of the hydraulic liquid the position of the respective pin 16 is located in a fixed position when the valve 19 is closed. If now a counter force 21 is exerted on the airplane component 40 on its side opposite the holding sections 12, 13 as schematically indicated by the arrows 21 in FIG. 2, the airplane component 40 is pressed against the holding sections 12, 13 or rather against the contact areas 16′ of all the pins 16 which are now in a contour true position. The pins 16 exert a holding force on the airplane component 40 that is opposed to the counter force 21 in order to hold the component in accordance with its contour. Thus, an exact adaptation of the holding pins or elements 16 to the shape of the airplane component 40 is assured in a contour true manner. Incidentally, the holding areas 16′ may themselves have component facing contours. Additionally, the holding areas 16′ may be formed by exchangeable pin tips which have different contours, whereby the contour true contact is improved. The pins themselves may be exchangeable for pins with differently contoured tips.

The valves 19 are opened again upon completion of the working of the airplane component 40. The holding device 10 may then be set onto another area to be worked of the airplane component, whereby the holding elements or pins 16 again adapt themselves to the respective surface contour of the airplane component. Thereafter, the valves 19 are closed again. Thus, the holding device 10 is a universal holding device which is adaptable within wide ranges, to any desired surface contours of airplane components or any other contoured surfaces.

The holding device 10 preferably comprises a mechanism for producing a biasing force on the holding element or pin 16 effective in the direction of the airplane component 40 to be held, for example, by a spring 24. The biasing force of the spring assures that in the rest position of a holding section 12, 13, that is in a state when the device 10 is not set on an airplane component, the pins 16 project maximally out of the support plate 11 with the spacing S. Thus, following removal of the holding device 10, the pins are automatically reset into a rest position, which is also the starting position. From this rest position an adaptation to any randomly shaped surface of an airplane component is possible.

The holding device preferably comprises a pressure metering device PS for measuring the pressure exerted by the airplane component on the holding device. This may, for example, be a device for measuring the hydraulic liquid pressure. The pressure signal thus measured may serve for monitoring the operation or, for example as a control value for controlling the valves 19.

When the pin or pins 16 are shifted by an electric drive the locking of the position of the pins 16 is achieved by switching off an electric drive. For this purpose the electric drive is preferably electrically controllable. Initially all pins 16 are suitably held in a maximally recessed position relative to the support plate 11. Then, the support plate 11 is placed in the zone of the surface 43 of the airplane component 40 to be worked and the pins 16 are driven out until they are in contact with the surface 43 of the airplane component 40. Preferably, an electronic control circuit 22 is provided, which switches off the electric drive when the counter force 21 exerted by or on the airplane component 40 and on the pins 16 reaches a predetermined value as measured by a pressure measuring device such as a pressure sensor PS. The output of the sensor PS is supplied to an input of the control 22. Another embodiment provides the electronic control circuit 22 with a memory 22′. A contour representing program is stored in the memory 22′ and used for controlling the position adjustment of the pins.

In the embodiment wherein the pins are driven by an electric drive, the contact pressure is preferably ascertained from rated values of the electric drive. For example, the rise of the power consumption of an electric drive motor in response to the pins 16 contacting the surface contour 43, may be used to generate a control signal for closing the valves to thereby lock the pins in their surface contacting position without further increasing the driving pressure while maintaining the contact pressure. Instead, the above mentioned pressure sensor PS may be used to provide a control signal for the valves 19. The control circuit is preferably so constructed, that the pins 16 are automatically returned into the rest position when the contact pressure is stopped by opening the valves 19 or by simply lifting the holding device 10 off the airplane component 40.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

1. A holding device for generating a retaining pressure on an airplane component 40 having a predetermined contour to be worked, said holding device (10) comprising a support (11), at least one holding element (16) movably connected to and projectable from said support (11) said at least one holding element (16) comprising a free end forming a contact area (16′) for contacting said airplane component (40) in a holding zone of said predetermined contour, a drive operatively connected to said at least one holding element (16) for adjusting a position of said at least one holding element (16) relative to said support (11) so that a spacing of said contact area (16′) from said support (11) is variable for conforming said spacing to said predetermined contour.

2. The holding device of claim 1, wherein said drive (15) is directly connected to said at least one holding element (16) for variably adjusting the position of said at least one holding element.

3. The holding device of claim 1, further comprising a locking mechanism (19) for releasably locking said at least one holding element (16) in an adjusted position.

4. The holding device of claim 3, further comprising control means (20) for selectively operating said locking mechanism.

5. The holding device of claim 1, further comprising an automatic control (22) operatively connected to said drive (15) for controlling said adjusting and thereby said spacing of said contact area (16′) from said support.

6. The holding device of claim 5, wherein said automatic control (22) comprises a memory (22′) for storing control information based on said predetermined contour for controlling said spacing in response to said predetermined contour.

7. The holding device of claim 1, further comprising a force source (24) positioned for applying a biasing force to said at least one holding element (16).

8. The holding device of claim 1, further comprising a force or pressure sensor (PS) for ascertaining any force or pressure effective between said contact area (16′) and said predetermined surface contour to provide a respective control signal for automatically switching off said drive and for returning said at least one holding element (16) into a starting position

9. The holding device of claim 1, further comprising a return spring (RS) positioned for returning said at least one holding element into a starting position.

10. The holding device of claim 1, wherein said drive is any one drive selected from a hydraulic drive, a pneumatic drive, an electric drive, a piezo-electric drive and an electromagnetic drive.
